(19) United States
(12) Patent Application Publication
(10) Pub. No.: US 2014/0320372 A1
(43) Pub. Date: Oct. 30, 2014

(54) DUAL WIRELESS COMMUNICATIONS DEVICE

(71) Applicant: HON HAI PRECISION INDUSTRY CO., LTD., New Taipei (TW)

(72) Inventor: JEN-CHIEH WU, New Taipei (TW)

(73) Assignee: HON HAI PRECISION INDUSTRY CO., LTD., New Taipei (TW)

(21) Appl. No.: 14/029,821

(22) Filed: Sep. 18, 2013

(30) Foreign Application Priority Data
Apr. 29, 2013 (TW) 102115191

(51) Int. Cl. H01Q 1/52

(52) U.S. Cl. CPC H01Q 1/521
USPC 343/853

(57) ABSTRACT

A dual wireless communications device includes a first antenna, a second antenna, a first wireless communication module, a second wireless communication module, an isolation module, and a processor. The first wireless communication module is connected to the first antenna and generates first radiation signals. The second wireless communication module is connected to the second antenna and generates second radiation signals. The isolation module isolates the first antenna from the second antenna. The processor is connected to the first wireless communication module, the second wireless communication module, and an adjustable attenuation unit. The processor calculates an isolation value between the first antenna and the second antenna, compares the isolation value to a predetermined threshold, and adjusts attenuation of the adjustable attenuation unit according to the comparison.

### BACKGROUND

1. Technical Field

The disclosure relates to dual system devices, and particularly to dual wireless communication devices.

2. Description of Related Art

In dual wireless communication devices, throughputs of the dual wireless communication devices can be significantly decreased by reducing interference between wireless signals of adjacent antennas of the dual wireless communication devices. Interference is reduced by increasing isolation value between the two antennas, and the isolation value is increased by spacing the two antennas further from each other. However, space in the dual wireless communication devices is limited, so it is difficult to increase the isolation value by spacing the two antennas apart from each other. Therefore, there is a need for a dual wireless communication device that can overcome the aforementioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of a first embodiment of a dual wireless communication device according to the present disclosure.

FIG. 2 is a schematic diagram of a second embodiment of a dual wireless communication device according to the present disclosure.

FIG. 3 is a schematic diagram of a third embodiment of a dual wireless communication device according to the present disclosure.

FIG. 4 is a schematic diagram of a fourth embodiment of a dual wireless communication device according to the present disclosure.

FIG. 5 is a schematic diagram of a fifth embodiment of a dual wireless communication device according to the present disclosure.

FIG. 6 is a schematic diagram of a sixth embodiment of a dual wireless communication device according to the present disclosure.

FIG. 7 is a schematic diagram of a seventh embodiment of a dual wireless communication device according to the present disclosure.

FIG. 8 is a circuit diagram of an eighth embodiment of a dual wireless communication device according to the present disclosure.

FIG. 9A is a circuit diagram of a first embodiment of a delay unit according to the present disclosure.

FIG. 9B is a circuit diagram of a second embodiment of a delay unit according to the present disclosure.

FIG. 10 is a flowchart of a first embodiment of a processor adjusting isolation value between a first antenna and a second antenna according to the present disclosure.

FIG. 11 is a diagram of antenna isolation value corresponding to adjustments of an adjustable attenuator according to the present disclosure.

FIG. 12 is a contrast diagram of isolation value of the disclosed dual wireless communication device and a traditional dual wireless communication device.

FIG. 13 is a contrast diagram of throughputs of the disclosed dual wireless communication device and a traditional dual wireless communication device in 802.11g standard and 802.11n HT20 standard.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

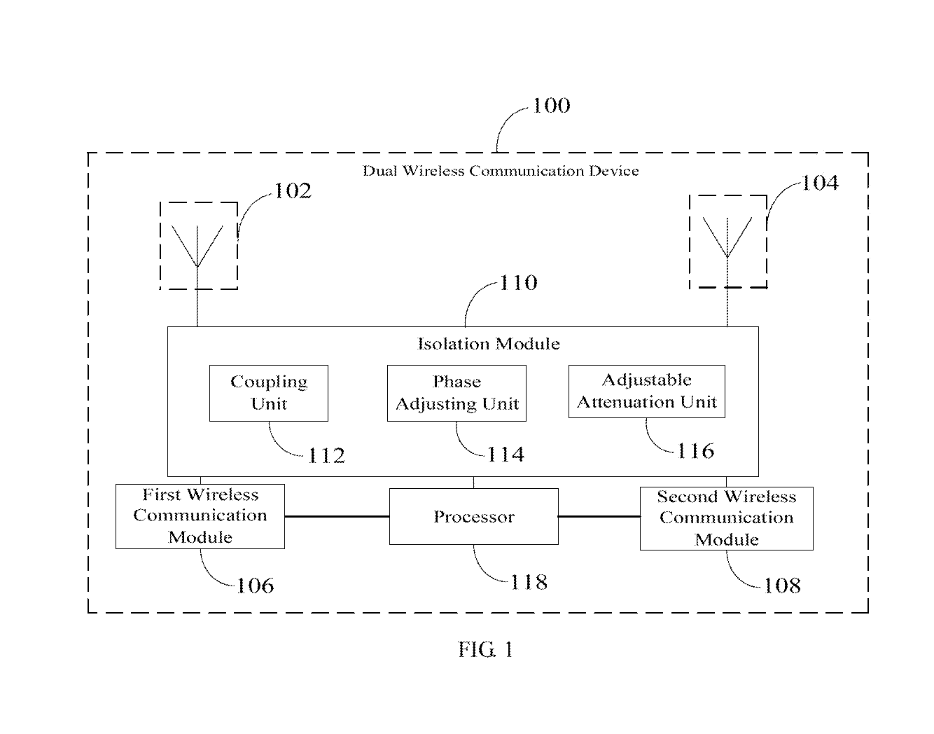

FIG. 1 is a schematic diagram of a first embodiment of a dual wireless communication device 100 according to the present disclosure. In one embodiment, the dual wireless communication device 100 comprises a first antenna 102, a second antenna 104, a first wireless communication module 106, a second wireless communication module 108, an isolation module 110, and a processor 118. The first wireless communication module 106 is connected to the first antenna 102 and generates first radiation signals. The first wireless communication module 106 sends the first radiation signals via the first antenna 102. The second wireless communication module 108 is connected to the second antenna 104 and generates second radiation signals. The second wireless communication module 108 sends the second radiation signals via the second antenna 104.

The isolation module 110 is connected between the first antenna 102 and the first wireless communication module 106, and is also connected between the second antenna 104 and the second wireless communication module 108. The isolation module 110 isolates the first antenna 102 from the second antenna 104. The isolation module 110 comprises a coupling unit 112, a phase adjusting unit 114, and an adjustable attenuation unit 116. The coupling unit 112 couples the first radiation signals to the second wireless communication module 108, and couples the second radiation signals to the first wireless communication module 106. The phase adjusting unit 114 adjusts phases of the first radiation signals and the second radiation signals. The adjustable attenuation unit 116 attenuates the first radiation signals and the second radiation signals.

The processor 118 is connected to the first wireless communication module 106, the second wireless communication module 108, and the adjustable attenuation unit 116. The processor 118 calculates an isolation value between the first antenna 102 and the second antenna 104, compares the isolation value to a predetermined threshold, and controls the adjustable attenuation unit 116 to attenuate the first or second coupled radiation signals according to the comparison. The isolation value is measured in decibels (dB).

The dual wireless communication device 100 can be dual system routers conforming to the IEEE 802.11 standards, or other dual wireless system devices.

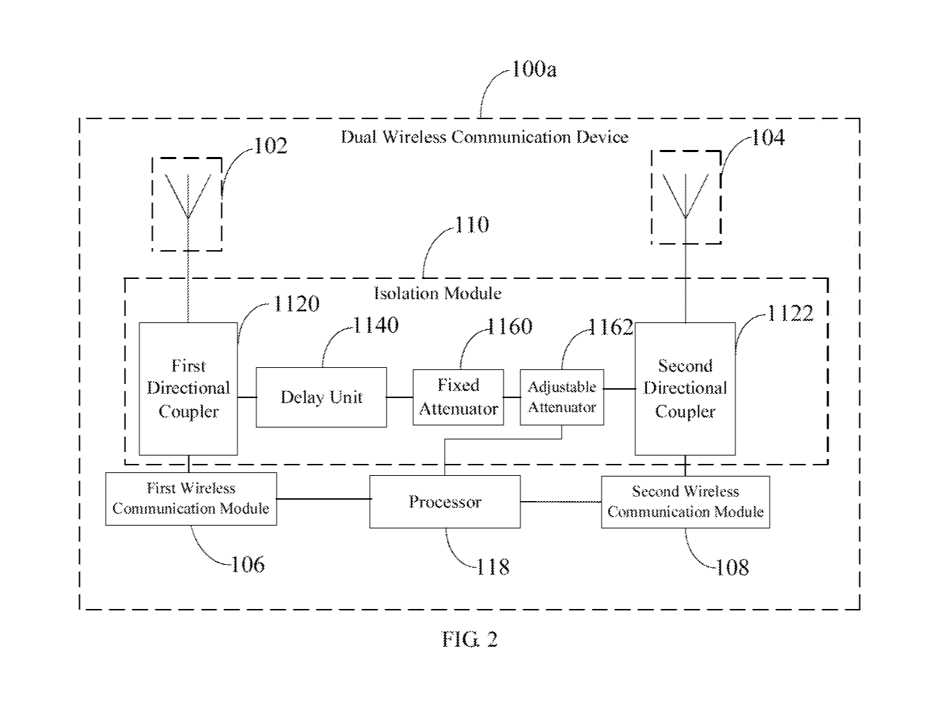

FIG. 2 is a schematic diagram of a second embodiment of a dual wireless communication device 100a according to the present disclosure. The dual wireless communication device 100a is similar to the dual wireless communication device 100 of the first embodiment. The difference between the dual wireless communication device 100a and the dual wireless communication device 100 is that the isolation module 110 comprises a first directional coupler 1120, a second directional coupler 1122, a delay unit 1140, a fixed attenuator 1160, and an adjustable attenuator 1162.

The first directional coupler 1120 couples the first radiation signals to generate first coupled signals. The second directional coupler 1122 couples the second radiation signals to generate second coupled signals.

The delay unit 1140 is connected to the first directional coupler 1120 and delays the first coupled signals to generate first delay coupled signals. The fixed attenuator 1160 is connected to the delay unit 1140 and attenuates the first delay coupled signals to generate first fixed attenuation coupled signals. The adjustable attenuator 1162 is connected between the fixed attenuator 1160 and the second directional coupler 1122, and the adjustable attenuator 1162 attenuates the first fixed attenuation coupled signals to generate first adjustable attenuation coupled signals.

The processor 118 is connected to the first wireless communication module 106, the second wireless communication module 108, and the adjustable attenuator 1162. The processor 118 calculates the isolation value between the first antenna 102 and the second antenna 104, compares the isolation value with the predetermined threshold, and adjusts attenuation of the adjustable attenuator 1162 according to the comparison.

The first directional coupler 1120 is connected between the first wireless communication module 106 and the first antenna 102. The first wireless communication module 106 generates the first radiation signals and sends the first radiation signals via the first antenna 102. The first wireless communication module 106 serves as a hotspot to communicate with wireless devices to offer wireless network access services for the wireless devices. The second directional coupler 1122 is connected between the second wireless communication module 108 and the second antenna 104. The second communication module 108 generates the second radiation signals and sends the second radiation signals via the second antenna 104. The second communication module 108 serves as a wireless device in communication with the hotspot to use the wireless network access services provided by the hotspot.

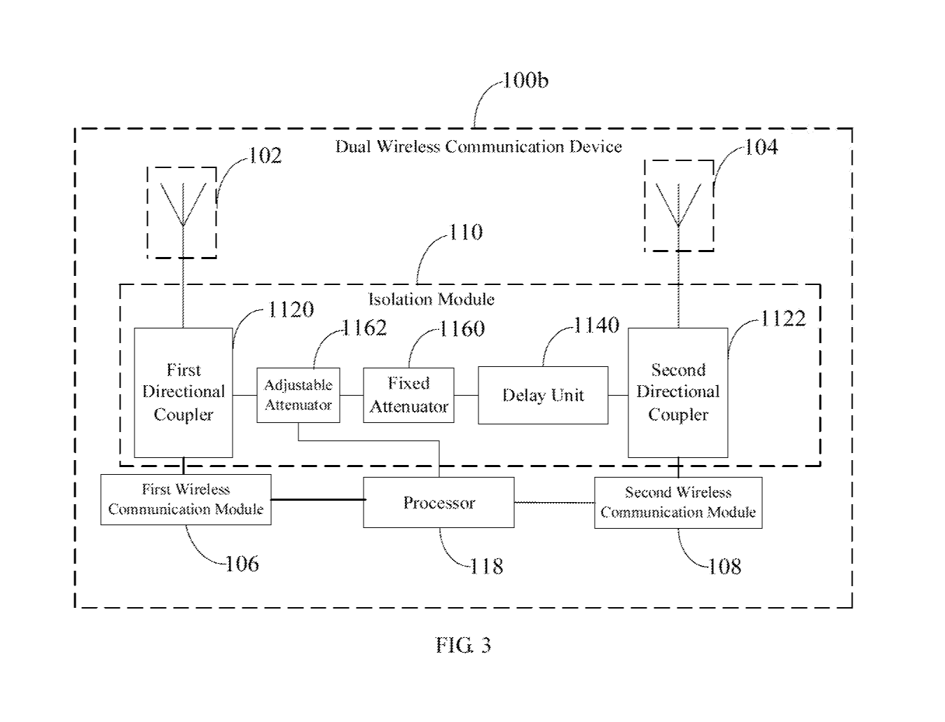

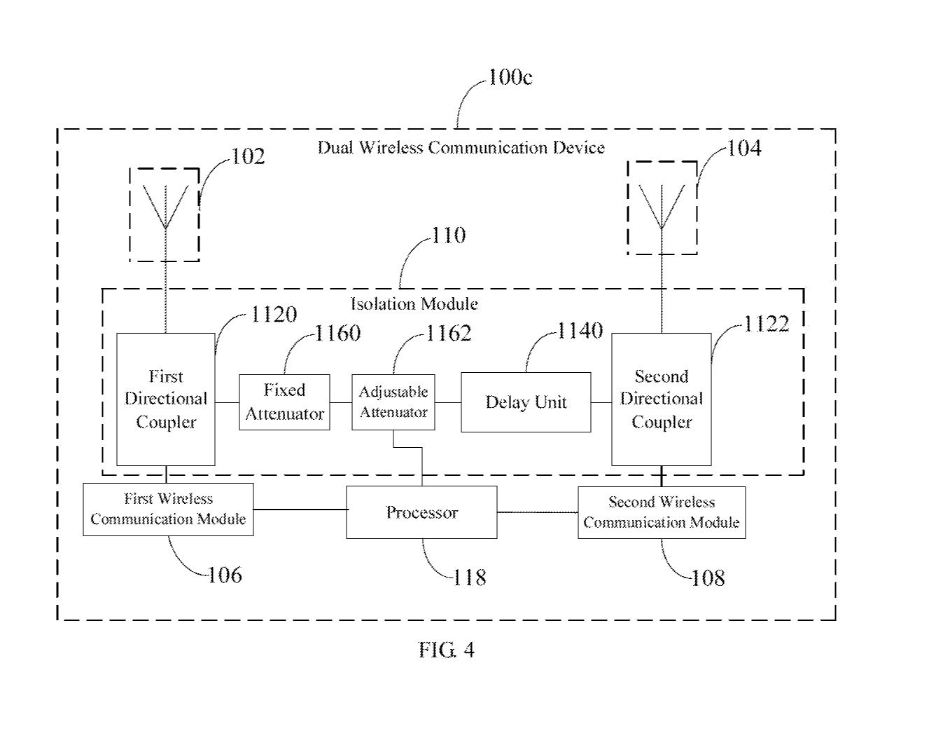

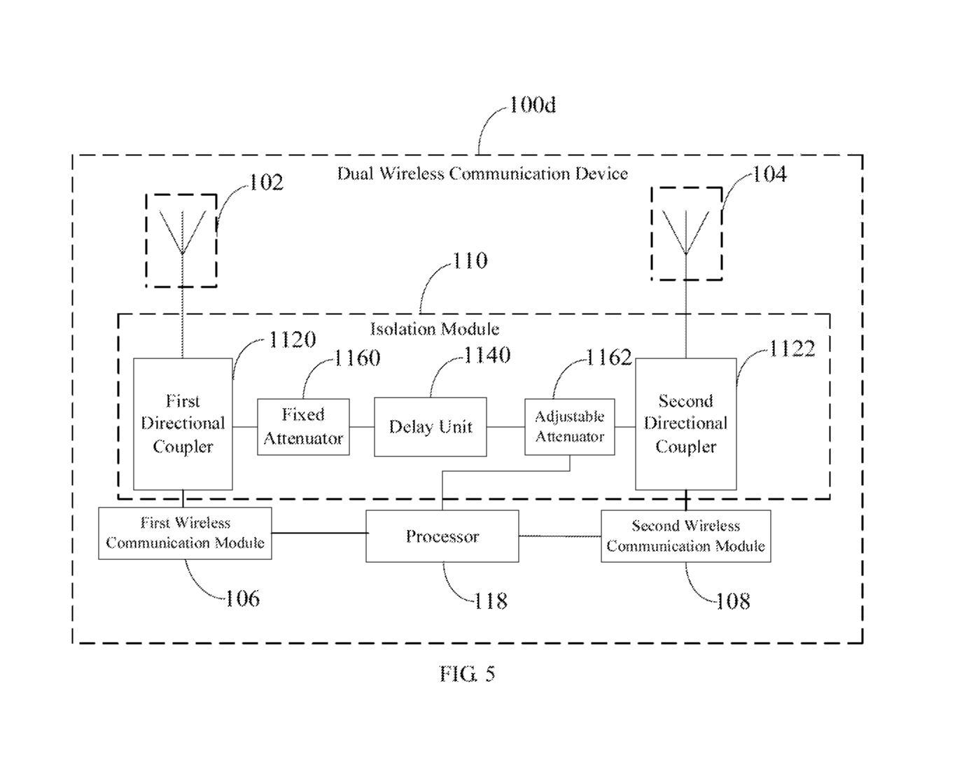

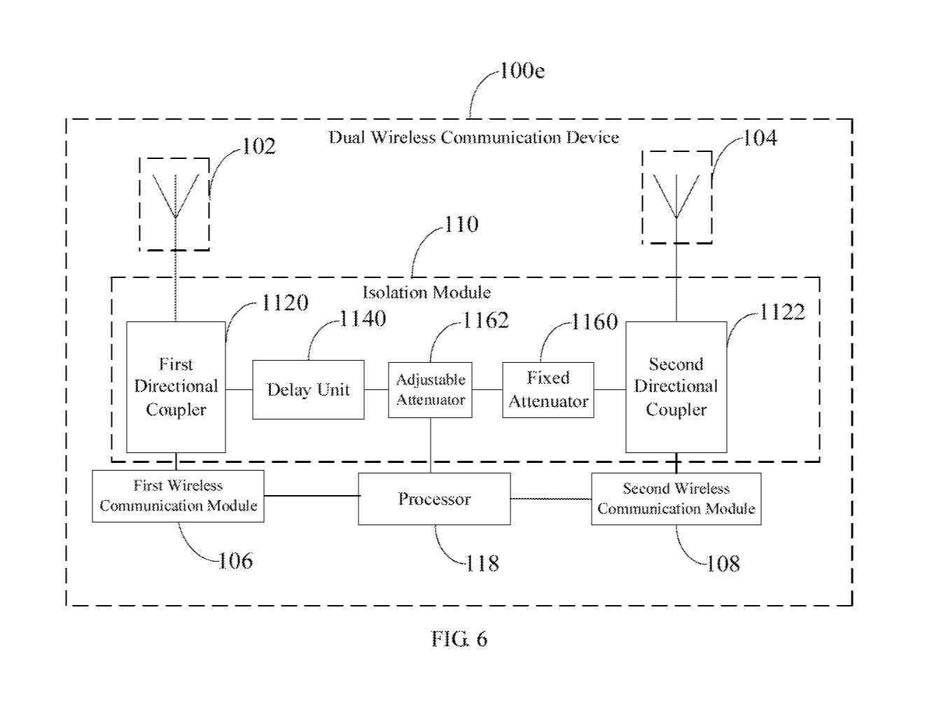

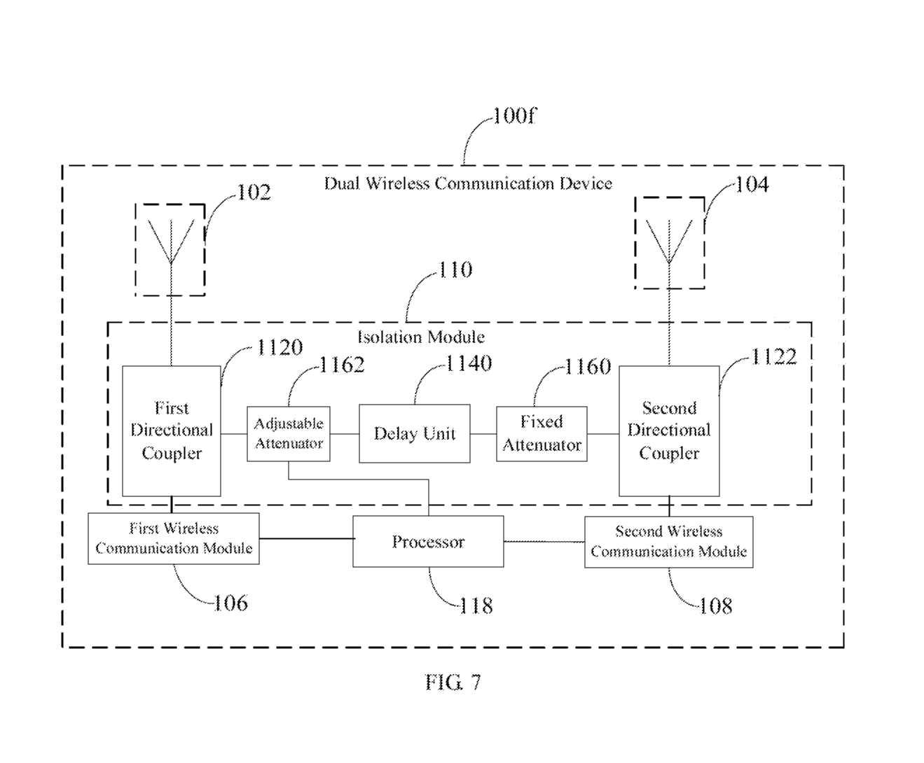

Electrical connection relationships among the delay unit 1140, the fixed attenuator 1160, and the adjustable attenuator 1162 can be changed according to a layout of electrical components. FIG. 3, FIG. 4, FIG. 5, FIG. 6 and FIG. 7 show different electrical connection relationships among the delay unit 1140, the fixed attenuator 1160, and the adjustable attenuator 1162 in other embodiments. Functions of the delay unit 1140, the fixed attenuator 1160, and the adjustable attenuator 1162 in FIG. 3, FIG. 4, FIG. 5, FIG. 6 and FIG. 7 are similar to functions of the delay unit 1140, the fixed attenuator 1160, and the adjustable attenuator 1162 of the second embodiment.

The phase adjusting unit 114 can be phase regulators or other types of phase adjusting modules.

In one embodiment, the dual wireless communication device 100a is a dual system router conforming to the IEEE 802.11 standard. In response to the dual system router downloading data from a server (not shown), the first wireless communication module 106 serves as an Access Point (AP) and generates the first radiation signals. The first wireless communication module 106 sends the first radiation signals to terminal devices via the first directional coupler 1120 and the first antenna 102, and the second wireless communication module 108 serves as a terminal device and receives the first radiation signals from the first wireless communication module 106 or receives radiation signals from other APs. In response to the dual system router uploading data to a server, the second wireless communication module 108 serves as a terminal device and generates the second radiation signals. The second wireless communication module 108 sends the second radiation signals to the first wireless communication module 106 via the second directional coupler 1122 and the second antenna 104, and the first wireless communication module 106 serves as an AP and receives the second radiation signals from the second wireless communication module 108, or receives the radiation signals from other terminal devices.

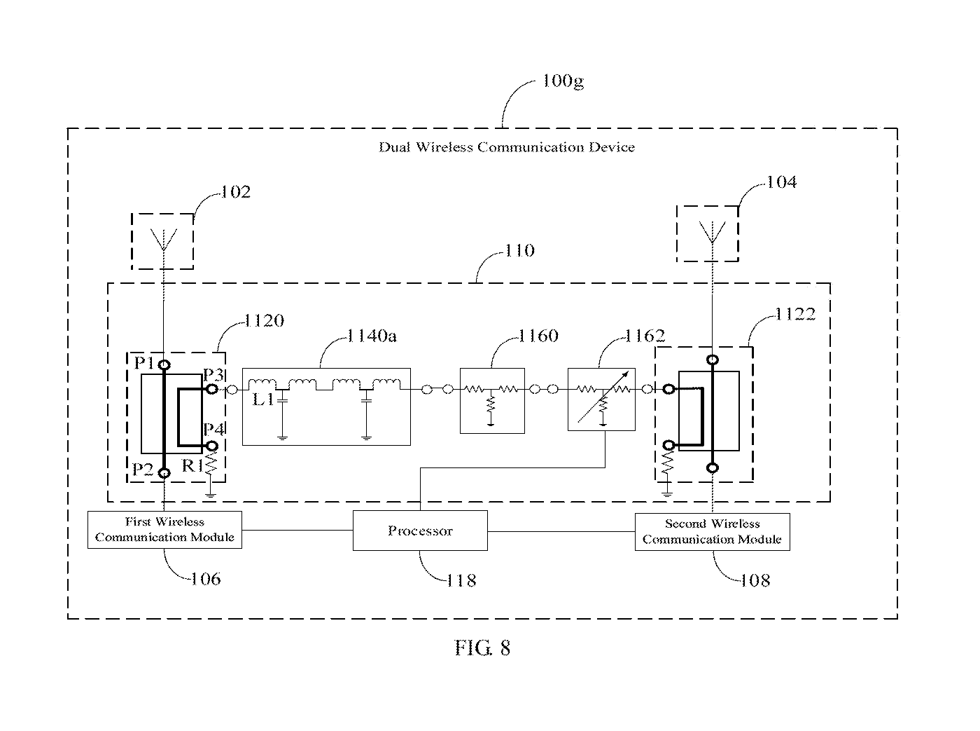

FIG. 8 is a circuit diagram of an eighth embodiment of a dual wireless communication device 100g according to the present disclosure. The isolation module 110 comprises the first directional coupler 1120, the second directional coupler 1122, the delay unit 1140a, the fixed attenuator 1160, and the adjustable attenuator 1162.

Adjustable attenuation range of the adjustable attenuator 1162 is 0-15 decibels (dB), and the adjustable attenuator 1162 adjusts the attenuation of the first coupled signals.

The first directional coupler 1120 couples the first radiation signals to generate the first coupled signals. The first directional coupler 1120 comprises a first port P1, a second port P2, a third port P3, and a fourth port P4. The first port P1 is an input and is connected to the first antenna 102. The second port P2 is an output and is connected to the first wireless communication module 106. The third port P3 is a coupling end and is connected to the delay unit 1140a. The fourth port P4 is grounded via a resistor R1.

The delay unit 1140a is connected to the first directional coupler 1120. The delay unit 1140a delays the first coupled signals to generate the first delay coupled signals.

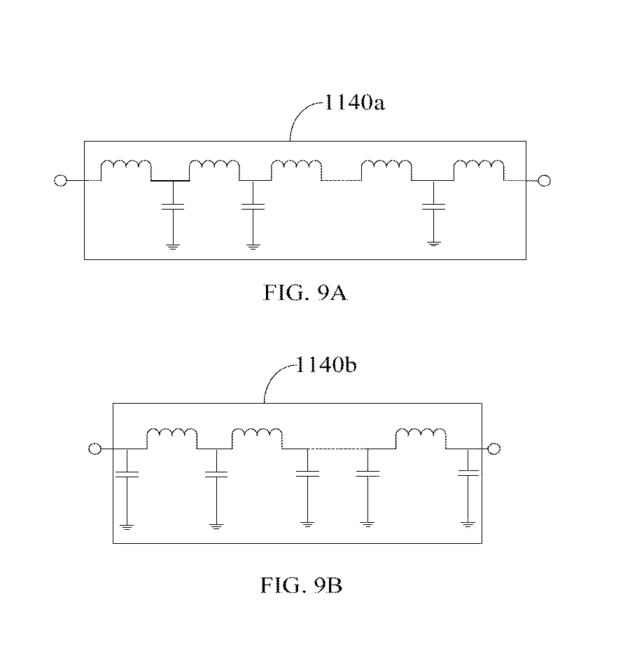

FIG. 9A is a circuit diagram of a first embodiment of the delay unit 1140a according to the present disclosure. The delay unit 1140a comprises a plurality of resonance oscillation units connected in series. Each of the resonance oscillation units comprises two inductors in series and a capacitor. A first end of the capacitor is connected to a node between the two inductors, and a second end of the capacitor is grounded.

FIG. 9B is a circuit diagram of a second embodiment of the delay unit 1140b according to the present disclosure. The delay unit 1140b comprises a plurality of resonance oscillation units connected in series. Each of the resonance oscillation units comprises an inductor and two capacitors. One capacitor is connected between a first end of the inductor and ground, and the other capacitor is connected between a second end of the inductor and ground.

In response to the first wireless communication module 106 generating the first radiation signals, the first directional coupler 1120 receives the first radiation signals via the second port and generates the first coupled signals. The first port of the first directional coupler 1120 transmits the first radiation signals to the first antenna 102. There is interference between the first antenna 102 and the second antenna 104. The second antenna 104 receives the first radiation signals when the first antenna 102 sends the first radiation signals.

When a value of the first radiation signals generated by the first wireless communication module 106 is 100 decibel milliwatt (dBm), the phases of the first radiation signals is 0 degrees. Coupling by the first directional coupler 1120 and the second directional coupler 1122 is both 20 dB, and the phases of the first directional coupler 1120 and the second directional coupler 1122 are both −90 degrees. The first radiation signals transmitted from the first antenna 102 to the second antenna 104 have a 300 degree phase delay, and the isolation value between the first antenna 102 and the second antenna 104 is 50 dB. The first radiation signals generated by the first communication module 106 are converted to first signals, and the first signals are sent to the second communication module 108 via the first antenna 102 and the second antenna 104. The value of the first signals is 50 dBm, and phases of the first signals are −300 degrees. The first radiation signals generated by the first communication module 106 are also converted to second signals, and the second signals are sent to the second communication module 108 via the first directional coupler 1120, the delay unit 1140a, the fixed attenuator 1160, the adjustable attenuator 1162, and the second directional coupler 1122. In order to avoid interference between the first antenna 102 and the second antenna 104, a value of the second signals should be 50 dBm, and phases of the second signals should be −120 degrees. In other words, the value of the first signals is equivalent to the value of the second signals, and the phase differences between the first signals and the second signals is 180 degrees, so that the first signals and the second signals cancel each other out in the second wireless communication module 108. A sum of the fixed attenuator 1160 and the adjustable attenuator 1162 should supply −10 dB attenuation, and the delay unit should supply a 60 degree delay.

In one embodiment, the value of the first radiation signals is greater than the value of the first coupled signals.

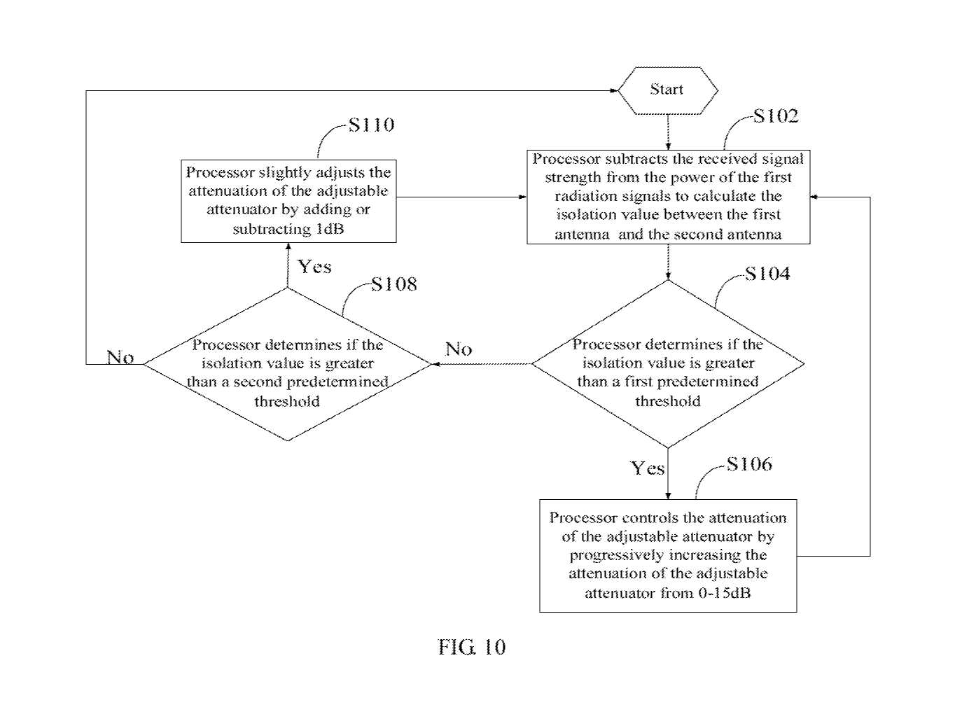

FIG. 10 is a flowchart of one embodiment according to the present disclosure of the processor 118 adjusting the isolation value between the first antenna 102 and the second antenna 104. The predetermined thresholds comprise a first predetermined threshold, and a second predetermined threshold. The first predetermined threshold is greater than the second predetermined threshold.

The processor 118 compares the isolation value to the first predetermined threshold and the second predetermined threshold, and adjusts the attenuation of the adjustable attenuator 1162 to make the isolation value less than the second predetermined threshold. In block S102, the processor 118 obtains a power (dBm) of the first radiation signals from the first wireless communication module 106 and obtains a received signal strength from the second wireless communication 108. The processor 118 subtracts the received signal strength from the power of the first radiation signals to calculate the isolation value between the first antenna 102 and the second antenna 104. In block S104, the processor 118 determines if the isolation value is greater than the first predetermined threshold. In block S106, in response to the isolation value being greater than the first predetermined threshold, the processor 118 controls the attenuation of the adjustable attenuator 1162 by progressively increasing the attenuation of the adjustable attenuator 1162 from 0-15 dB. In block S108, in response to the isolation value being less than the first predetermined threshold, the processor 118 determines if the isolation value is greater than the second predetermined threshold. In block S110, in response to the isolation value being greater than the second predetermined threshold, the processor 118 slightly adjusts the attenuation of the adjustable attenuator 1162 by adding or subtracting 1 dB.

In one embodiment, the adjustable attenuator 1162 by progressively increasing the attenuation of the adjustable attenuator 1162 from 0-15 dB is that the attenuation of the adjustable attenuator 1162 is adjusted by scanning from 0 dB to 15 dB to search the need attenuation.

In one embodiment, if a present attenuation of the adjustable attenuator 1162 is 4 dB, and the isolation value is between the first predetermined threshold and the second predetermined threshold, the processor 118 adds 1 dB to or subtracts 1 dB from the attenuation of the adjustable attenuator 1162 to determine if the isolation value is less than the second predetermined threshold.

In one embodiment, the isolation value between the first antenna 102 and the second antenna 104 is an absolute value number, so the greater the absolute value number, the greater the isolation value.

In one embodiment, the predetermined thresholds further comprise a third predetermined threshold, and a fourth predetermined threshold. The third predetermined threshold is greater than the fourth predetermined threshold. The processor 118 further obtains the received signal strength from the second wireless communication module 108. The processor 118 compares the received signal strength with the third predetermined threshold and the fourth predetermined threshold. The processor 118 adjusts the attenuation of the adjustable attenuator 1162 to make the received signal strength be less than the fourth predetermined threshold.

In one embodiment, the third predetermined threshold and the fourth predetermined threshold are determined by wireless types of the dual wireless communication deceive 100. When the dual wireless communication deceive 100 conforms to the IEEE 802.11 standards, the fourth predetermined threshold can be −40 dB, and the third predetermined threshold can be −30 dB. The processor 118 adjusts the attenuation of the adjustable attenuator 1162 to make the received signal strength be less than −40 dB. Thus, the processor 118 adjusts the attenuation of the adjustable attenuator 1162 to increase the isolation value between the first antenna 102 and the second antenna 104.

The isolation value between the first antenna 102 and the second antenna 104 is equivalent to the received signal strength of the second wireless communication module 108 subtracted from the value of the power of the first radiation signals of the first wireless communication module 106. The second predetermined threshold is equivalent to the value of the power of the first radiation signals of the first wireless communication module 106 subtracted from the fourth predetermined threshold. The first predetermined threshold is equivalent to the power of the first radiation signals of the first wireless communication module 106 subtracted from the third predetermined threshold.

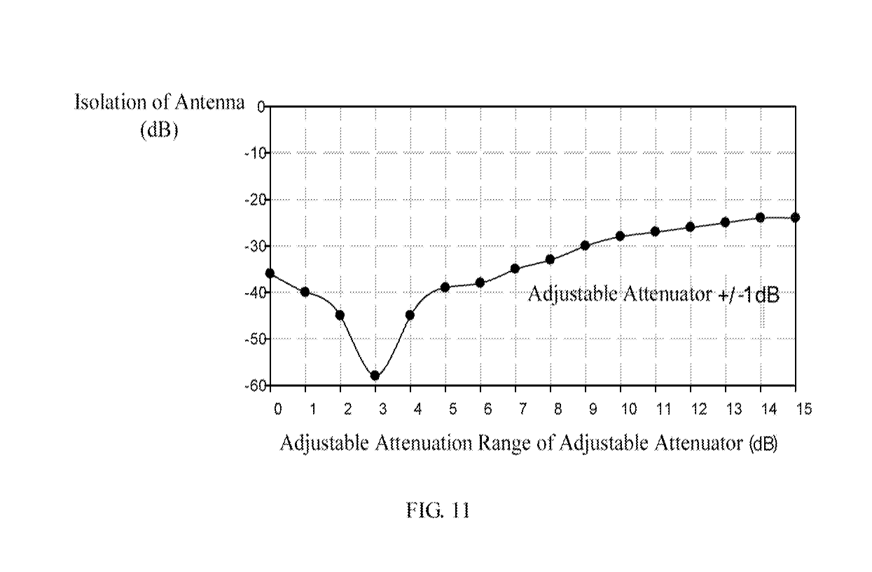

FIG. 11 is a diagram showing how the isolation value changes when the attenuation of the adjustable attenuator 1162 is changed. The Y-axis is the isolation value between the first antenna 102 and the second antenna 104, and the X-axis is the adjustable attenuation range of the adjustable attenuator 1162.

The third predetermined threshold is −30 dB, and the fourth predetermined threshold is −40 dB. According to FIG. 11, the best attenuation of the adjustable attenuator 1162 is 3 dB, and the corresponding isolation value is far less than the fourth predetermined threshold. If the present attenuation of the adjustable attenuator 1162 is 5 dB, the adjustable attenuator 1162 can make the isolation value less than −40 dB just by subtracting 1 dB.

A time for the processor 118 to slightly adjust the attenuation of the adjustable attenuator 1162 by adding or subtracting 1 dB is far less than a time for the processor 118 to adjust the attenuation of the adjustable attenuator 1162 by scanning from 0 dB. Therefore, the isolation value between the first antenna 102 and the second antenna 104 can be quickly increased by the processor 118 slightly adjusting the attenuation of the adjustable attenuator 1162.

In one embodiment, in response to a change in a present environment of the dual wireless communication device 100, the processor 118 readjusts the attenuation of the adjustable attenuator 1162. For example, if the isolation value between the first antenna 102 and the second antenna 104 is changed, the processor 118 recalculates the isolation value between the first antenna 102 and the second antenna 104, and adjusts the attenuation of the adjustable attenuator 1162 to make the recalculated isolation value be less than the second predetermined threshold.

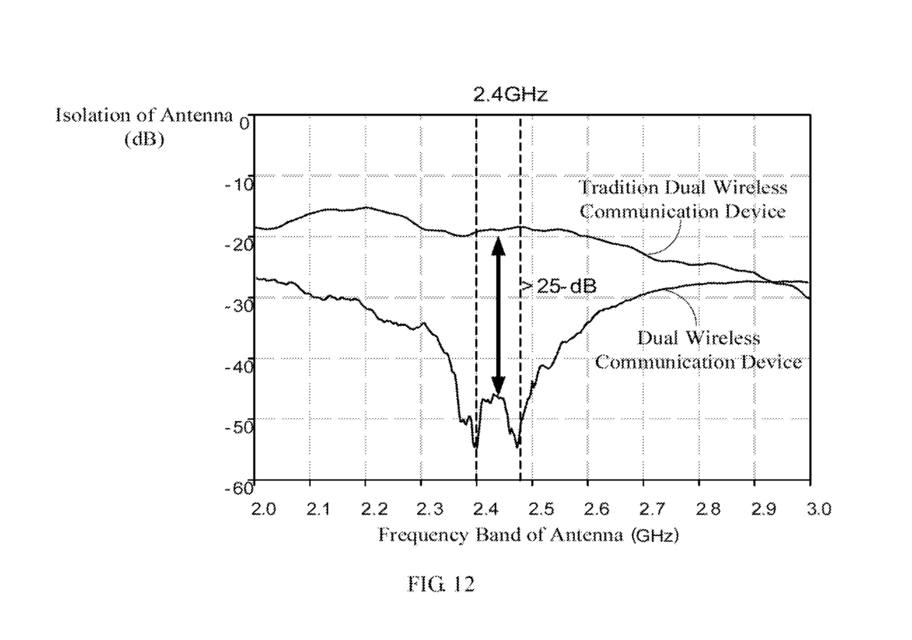

FIG. 12 is a contrast diagram of the isolation value between the dual wireless communication device 100 and a traditional dual wireless communication device. The Y-axis is the isolation value between the first antenna 102 and the second antenna 104, and the X-axis is a frequency band of the first antenna 102 and the second antenna 104.

In one embodiment, the frequency of the first antenna 102 and the second antenna 104 is 2.4 gigahertz (GHz), and the isolation value between the first antenna 102 and the second antenna 104 of the traditional dual wireless communication device is −20 dB. In contrast, the isolation value between the first antenna 102 and the second antenna 104 of the dual wireless communication device 100 is less than −45 dB. Thus, the dual wireless communication device 100 increases the isolation value between the first antenna 102 and the second antenna 104 so that interference between the first antenna 102 and the second antenna 104 is reduced.

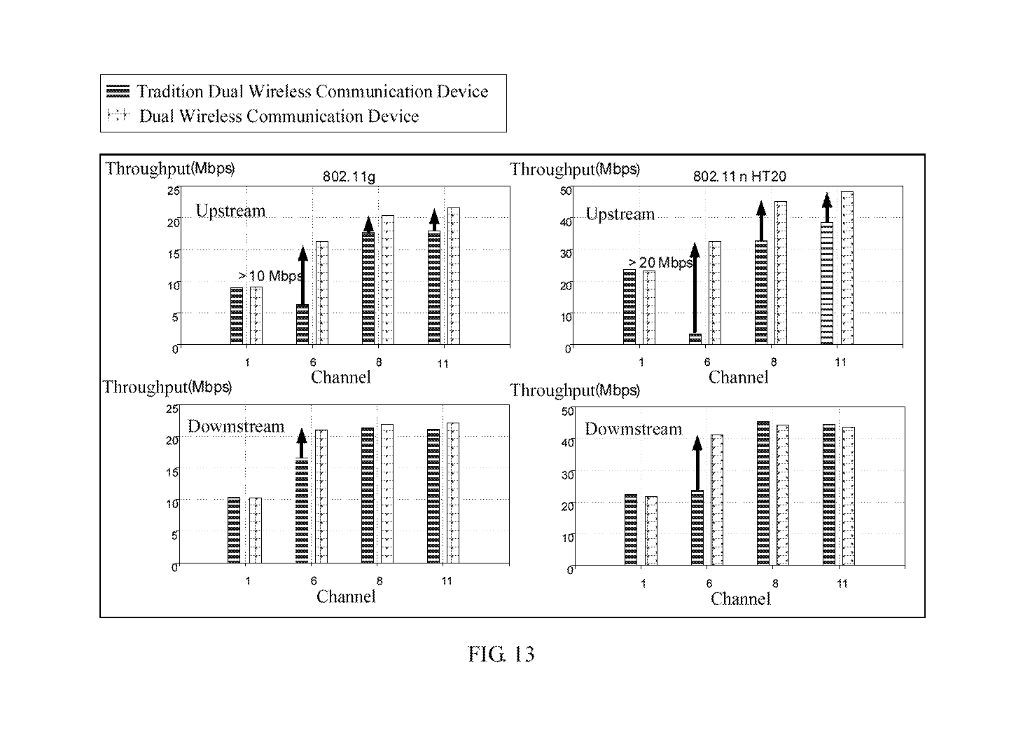

FIG. 13 is a contrast diagram of throughputs between a dual wireless communication device 100 and a traditional dual wireless communication device in 802.11g standard and 802.11n HT20 standard according to the present disclosure. The Y-axis is throughputs of the dual wireless communication device 100 and the traditional dual wireless communication device, and the X-axis is channels of the dual wireless communication device 100 and the traditional dual wireless communication device. The throughputs of the dual wireless communication device 100 are greater than the throughputs of the traditional dual wireless communication device in 802.11g standard and 802.11n HT20 standard. The throughputs of the dual wireless communication device 100 also increase upstream and downstream in channels 1, 6, 8, 11.

The foregoing disclosure of various embodiments has been presented for the purposes of illustration. It is not intended to be exhaustive or to limit the invention to the precise forms disclosed. Many variations and modifications of the embodiments described herein will be apparent to one of ordinary skill in the art in the light of the above disclosure. The scope of the invention is to be defined only by the claims appended hereto and their equivalents.

What is claimed is:

1. A dual wireless communications device, comprising:
a first antenna;
a second antenna;
a first wireless communication module connected to the first antenna, the first wireless communication module generating first radiation signals and sending the first radiation signals via the first antenna;
a second wireless communication module connected to the second antenna, the second wireless communication module generating second radiation signals and sending the second radiation signals via the second antenna;
an isolation module connected between the first antenna and the first wireless communication module and connected between the second antenna and the second wireless communication module, the isolation module isolating the first antenna from the second antenna, wherein the isolation module comprises:
a coupling unit coupling the first radiation signals to the second wireless communication module and coupling the second radiation signals to the first wireless communication module;
a phase adjusting unit adjusting phases of the first coupled radiation signals and the second coupled radiation signals; and
an adjustable attenuation unit attenuating the first coupled radiation signals and the second coupled radiation signals; and
a processor connected to the first wireless communication module, the second wireless communication module, and the adjustable attenuation unit; the processor calculating an isolation value between the first antenna and the second antenna, and comparing the isolation with a predetermined threshold, and adjusting attenuation of the adjustable attenuation unit according to the comparison.

2. The dual wireless communications device of claim 1, wherein the coupling unit comprises:
a first directional coupler coupling the first radiation signals to generate first coupled signals; and
a second directional coupler coupling the second radiation signals to generate second coupled signals.

3. The dual wireless communications device of claim 2, wherein the phase adjusting unit comprises a delay unit connected to the first directional coupler, and the delay unit delays the first coupled signals to generate first delay coupled signals;
wherein the adjustable attenuation unit comprises:
a fixed attenuator connected to the delay unit, the fixed attenuator attenuating the first delay coupled signals to generate first fixed attenuation coupled signals; and
an adjustable attenuator connected between the fixed attenuator and the second directional coupler, the adjustable attenuator attenuating the first fixed attenuation coupled signals to generate first adjustable attenuation coupled signals.

4. The dual wireless communications device of claim 3, wherein the delay unit comprises a plurality of resonance oscillation units connected in series.

5. The dual wireless communications device of claim 1, wherein the processor calculates the isolation value between the first antenna and the second antenna by subtracting a received signal strength of the second wireless communication module from a power of the first radiation signals sent by the first wireless communication module.

6. The dual wireless communications device of claim 3, wherein the predetermined threshold comprises a first predetermined threshold and a second predetermined threshold, the first predetermined threshold is greater than the second predetermined threshold, wherein the processor further determines if the isolation value is between the first predetermined threshold and the second predetermined threshold.

7. The dual wireless communications device of claim 6, wherein in response to the isolation value being greater than the first predetermined threshold, the processor increases the isolation value between the first antenna and the second antenna by progressively increasing the attenuation of the adjustable attenuator starting from a minimum of an attenuation range of the adjustable attenuator.

8. The dual wireless communications device of claim 6, wherein in response to the isolation value between the first predetermined threshold and the second predetermined threshold, the processor slightly adjusts the attenuation of the adjustable attenuator.

9. The dual wireless communications device of claim 2, wherein the adjustable attenuation unit comprises:
an adjustable attenuator connected to the first directional coupler, the adjustable attenuator attenuating the first coupled signals to generate first adjustable attenuation coupled signals; and
a fixed attenuator connected to the adjustable attenuator, the fixed attenuator attenuating the first adjustable attenuation coupled signals to generate first fixed attenuation coupled signals;
wherein the phase adjusting unit comprises a delay unit connected between the fixed attenuator and the second directional coupler, and the delay unit delays the first fixed attenuation coupled signals to generate first delay coupled signals.

10. The dual wireless communications device of claim 2, wherein the adjustable attenuation unit comprises:
a fixed attenuator connected to the first directional coupler, the fixed attenuator attenuating the first coupled signals to generate first fixed attenuation coupled signals; and
an adjustable attenuator connected to the fixed attenuator, the adjustable attenuator attenuating the first fixed attenuation coupled signals to generate first adjustable attenuation coupled signals;
wherein the phase adjusting unit comprises a delay unit connected between the adjustable attenuator and the second directional coupler, the delay unit delays the first adjustable attenuation coupled signals to generate first delay coupled signals.

11. The dual wireless communications device of claim 2, wherein the adjustable attenuation unit comprises:
a fixed attenuator connected to the first directional coupler, the fixed attenuator attenuating the first coupled signals to generate first fixed attenuation coupled signals; and
an adjustable attenuator connected to the second directional coupler;
wherein the phase adjusting unit comprises a delay unit connected between the fixed attenuator and the adjustable attenuator, the delay unit delays the first fixed attenuation coupled signals to generate first delay coupled signals;
wherein the adjustable attenuator further connected to the delay unit, the adjustable attenuator attenuates the first delay coupled signals to generate first adjustable attenuation coupled signals.

12. The dual wireless communications device of claim 2, wherein the phase adjusting unit comprises a delay unit connected to the first directional coupler, the delay unit delays the first coupled signals to generate first delay coupled signals;
wherein the adjustable attenuation unit comprises:
an adjustable attenuator connected to the delay unit, the adjustable attenuator attenuating the first delay coupled signals to generate first adjustable attenuation coupled signals; and
a fixed attenuator connected between the adjustable attenuator and the second directional coupler, the fixed attenuator attenuating the first adjustable attenuation coupled signals to generate first fixed attenuation coupled signals.

13. The dual wireless communications device of claim 2, wherein the adjustable attenuation unit comprises:
an adjustable attenuator connected to the first directional coupler, the adjustable attenuator attenuating the first coupled signals to generate first adjustable attenuation coupled signals; and
a fixed attenuator connected to the second directional coupler;
wherein the phase adjusting unit comprises a delay unit connected to the adjustable attenuator, the delay unit delays the first adjustable attenuation coupled signals to generate first delay coupled signals;
wherein the fixed attenuator further connected to the delay unit, the fixed attenuator attenuates the first delay coupled signals to generate first fixed attenuation coupled signals.
